(19) United States
(12) Patent Application Publication
(10) Pub. No.: US 2019/0033264 A1
(43) Pub. Date: Jan. 31, 2019

(54) Equipment For Fatigue Testing At Ultrasonic Frequencies In The Multiaxial Regime-Axial And Torsional Directions

(71) Applicant: Instituto Superior Tecnico, Lisboa (PT)

(72) Inventors: Mario Alberto Silveira Costa Vieira, Queluz (PT); Antonio Manuel Relogio Ribeiro, Queluz (PT); Manuel Jose Moreira De Freitas, Lisboa (PT); Luis Filipe Galrao Dos Reis, Rio De Mouro (PT)

(21) Appl. No.: 16/074,935

(22) PCT Filed: Jan. 24, 2017
(86) PCT No.: PCT/PT2017/000001

§ 371 Date: Aug. 2, 2018

(30) Foreign Application Priority Data
Feb. 4, 2016 (PT) 109134

(51) Int. Cl. G01N 29/22; G01N 29/04; G01M 7/02

(52) U.S. Cl. CPC G01N 29/22; G01M 5/0025; G01M 7/022; G01N 29/043

(57) ABSTRACT

The present invention refers to an equipment that allows the performance of fatigue testing at ultrasonic frequencies in a multiaxial loading, more specifically biaxial. The equipment is formed by two components, the horn (1) and the specimen (5), which are coupled with each other. The horn (1) and the specimen (5) possess such geometry that their resonant frequency which, is relevant for the testing, is synchronized with the excitation frequency of the exciter, so that the whole equipment vibrates in free regime. Through its vibration mode, the horn (1) transforms the pure axial cyclic movement which it receives from the exciter into a mixed movement comprised of axial and torsional cyclic and in-phase movements. The specimen (5) possesses, synchronized at the same frequency, its first axial vibration mode and its third torsional vibration mode.

### FIELD OF INVENTION

The present invention refers to an equipment that allows the performance of fatigue testing at ultrasonic frequencies in a multiaxial regime—axial and torsional, using a commercial ultrasonic exciter. The use of this type of exciters allows to reach, in short, time, numbers of cycles in the billions of millions, or more. For example, a conventional multiaxial hydraulic fatigue machine, which could operate at 50 Hz, would take more than half a year to reach 10⁹ cycles. A 20 kHz piezoelectric exciter would only take 14 hours.

This type of equipment will allow, for the first time, to study and evaluate the behavior of certain metallic materials in the region of large number of cycles in the multiaxial regime—axial and torsional.

This type of testing is particularly relevant for the automotive and aerospace industries, where several components are subjected to cyclic multiaxial loadings with cycle numbers that often exceed billions.

### STATE OF ART

Fatigue tests in the region of very high number of cycles are a relatively recent area of research, and there are no standards to uniform this type of testing. However, because they allow the understanding of the mechanical behavior of the materials in regimes that had not been previously studied, they have been the object of intense attention by several researchers and research centers around the world.

The first type of tests reported relates to uniaxial fatigue tests, where a uniaxial ultrasonic exciter excites the entire system (exciter, horn and specimen) to its resonant frequency, vibrating in a free regime. More recently, torsional and three-point flexion tests have been reported. There are also developments in the use of this type of tests on contact fatigue.

There is currently no equipment for conducting multiaxial fatigue tests using ultrasonic exciters. There are, however, a number of equipment on the market that perform multiaxial tests using hydraulic exciters (for example: U.S. Pat. No. 7,509,882, CN103149022B, US2002162400A1, WO2012156606A1, among many others).

Some inventions, based on the same conceptual principle of the present invention, have been reported (EP 2243449 A1, U.S. Pat. No. 6,077,285A, 20010011176 A1). However, besides the noticeable design differences, the purpose of these inventions focuses on different research areas.

For example, U.S. Pat. No. 6,077,285 A relates to a surgical ultrasonic device suitable for ophthalmic procedures. This document, besides having a totally different purpose from that of the present invention, utilizes two piezoelectric exciters and is devoid of any specimen.

The object of the present invention is, therefore, to present an equipment which overcomes the drawbacks of the prior art, by specifically presenting an equipment which enables fatigue tests to be carried out at ultrasonic frequencies in multiaxial loading, more specifically biaxial—axial and torsional.

### SUMMARY OF THE INVENTION

The present invention refers to an equipment for multiaxial fatigue testing at ultrasonic frequencies using an axial ultrasonic exciter, characterized in that the referred axial ultrasonic exciter is coupled to a horn (1), which contains a plurality of oblique slits (3) on the conical surface of revolution, inclined at a certain angle with respect to the axis of the horn (1), being coupled to a cylindrical shaped specimen (5) by means of a mechanical joint, in which the specimen (5) has an upper throat (7), a central throat (8) and a lower throat (9), with the equipment operating in the resonant regime of the exciter, horn (1) and specimen (5).

The horn (1) and the specimen (5) have such geometry that their resonant frequency which is relevant to the test is synchronized to the exciter's excitation frequency, so that the whole assembly vibrates in a free regime.

Through its vibration mode, the horn (1) transforms the pure cyclic axial movement, which it receives from the exciter in a mixed movement composed of axial and torsional cyclical and in-phase movements. The specimen (5) has, at the same frequency, its first axial mode of vibration and its third torsional mode of vibration.

### DETAILED DESCRIPTION OF THE INVENTION

The present invention refers to an equipment for fatigue testing at ultrasonic frequencies on a multiaxial loading, more specifically biaxial—axial and torsional. The equipment, is formed by two components, the horn (1) and the specimen (5), which are coupled with each other.

The equipment is constituted by a horn (1), containing a plurality of oblique slits (3) on the conical revolving surface, inclined at a certain angle with respect to the axis of the horn (1), coupled to a specimen (5) with a cylindrical format through a mechanical joint, which possesses an upper throat (7), a central throat (8) and a lower throat (9), operating in the resonant regime of the exciter, horn (1) and specimen (5). Fatigue tests are performed at ultrasonic frequencies in multiaxial loading, more specifically biaxial—axial and torsional.

The horn (1) and the specimen (5) have such geometry that their resonant frequency, which is relevant to the test is synchronized to the exciter's excitation frequency, so that the whole assembly vibrates in a free regime.

Through its vibration mode, the horn (1) transforms the pure cyclic axial movement which it receives from the exciter in a mixed movement composed of axial and torsional cyclical and in-phase movements.

The horn (1) has dimensions depending on the material from which the horn (1) is formed.

The specimen (5) has, at the same frequency, its first axial mode of vibration and its third torsional mode of vibration.

The specimen (5) has overall dimensions dependent on the material from which the specimen (5) is formed.

The equipment, shown in FIG. 6, is formed by a horn (1) and a specimen (5), which are coupled together by means of a mechanical joint. The equipment is attached to the ultrasonic exciter by a mechanical joint.

The horn (1) has a mixed vibration mode at the excitation frequency of the ultrasonic exciter. The horn (1) contains a plurality of oblique slits (3) relative to its axis of revolution which are responsible for generating the rotational movement on the contact surface (4) between the horn (1) and the specimen (5), at the excitation frequency.

The specimen (5) has two modes of vibration at the resonant frequency of the ultrasonic exciter. An axial vibration mode and a torsional vibration mode. Both modes are excited by the horn (1). The relationship between the magnitude with which each mode is excited depends on the geometry of the oblique slits (3) of the horn (1).

The geometry and the mixed vibration mode of the specimen (5) promote the stress concentration in the central throat (8), the one to be tested. The stress field in this central, throat (8) is biaxial, with, a normal stress and a shear stress. In this way, it is possible to perform multiaxial fatigue tests using ultrasonic exciters, allowing the properties of different materials to be obtained for very high cycle numbers when subjected to multiaxial loads.

### Description of FIGURES

FIG. 1 shows the horn (1) formed, by a thread connection to the ultrasonic exciter, a contact surface (2) of the horn (1) with the exciter, a plurality of oblique slits (3) and a contact surface (4) of the horn (1) with the specimen (5).

FIG. 2 shows the specimen (5) formed by a contact surface (6) of the specimen (5) with the horn (1), an upper throat (7), a central throat (8) and a lower throat (9).

FIG. 3 shows the computational mode of vibration of the assembly formed by the horn (1) and the specimen (5) at the test frequency, where the black color is associated with the largest displacements and the white color is associated with the smallest displacements. It is also possible to identify the oblique slits (3) of the horn (1) and the upper throat (7), the central throat (8) and the lower throat (9) of the specimen (5).

FIG. 4 shows the torsional computational vibration mode of the specimen (5), where there is a vibration node in the upper throat (7), a vibration node in the central throat (8) and a vibration node in the lower throat (9). For this mode, the axial displacement is zero throughout the specimen (5).

FIG. 5 shows the axial computational vibration mode of the specimen (5), where there is a vibration node in the central throat (8). It is also possible to identify the upper throat (7) and the lower throat (9). For this mode, the rotational displacement is zero throughout the specimen (5).

FIG. 6 shows the side view of the assembly of the horn (1) with the specimen (5). It is possible to identify the contact surface (2) of the horn (1) with the ultrasonic exciter, the oblique slits (3), the contact surface (4) of the horn (1) with the specimen (5) and the contact, surface (6) of the specimen (5) with the horn (1), the specimen (5) and the upper throat (7), the central throat (8) and the lower throat (9) of the specimen (5).

FIG. 7 shows the equipment of the present invention, where the horn (1) and the specimen (5) are observed.

FIG. 8 shows the two temporal signals acquired by two vibrometers in the rotational measurements of the specimen (5).

FIG. 9 shows the three temporal signals acquired by the three-channel rosette strain gage installed in the central throat (8).

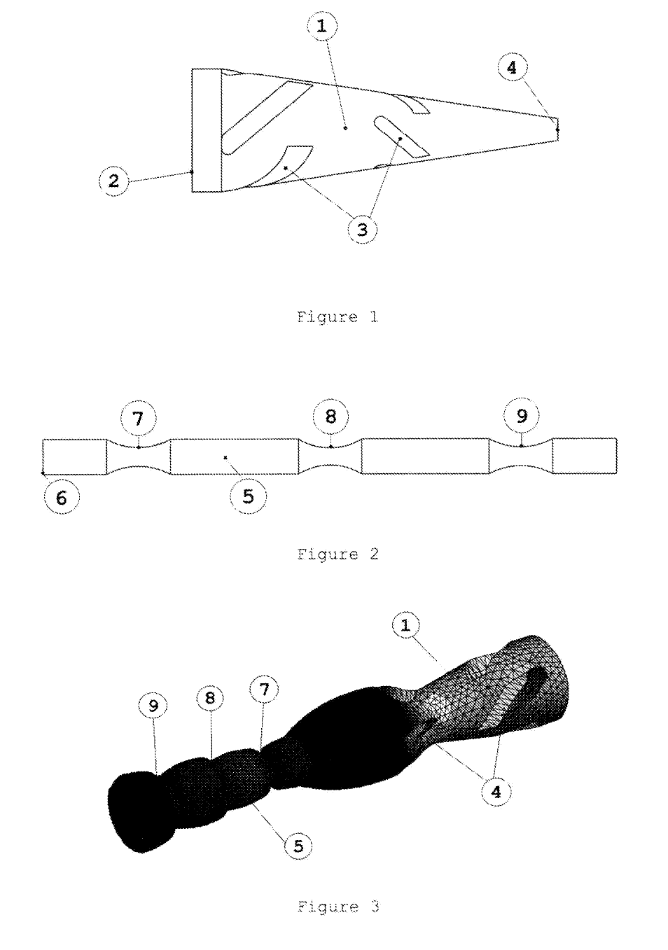

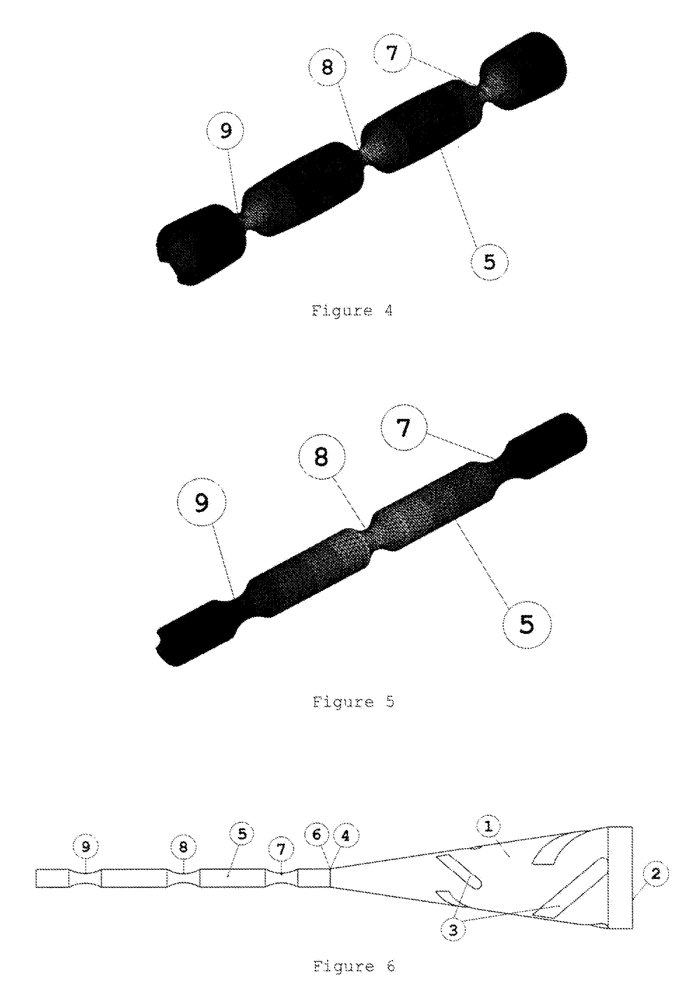

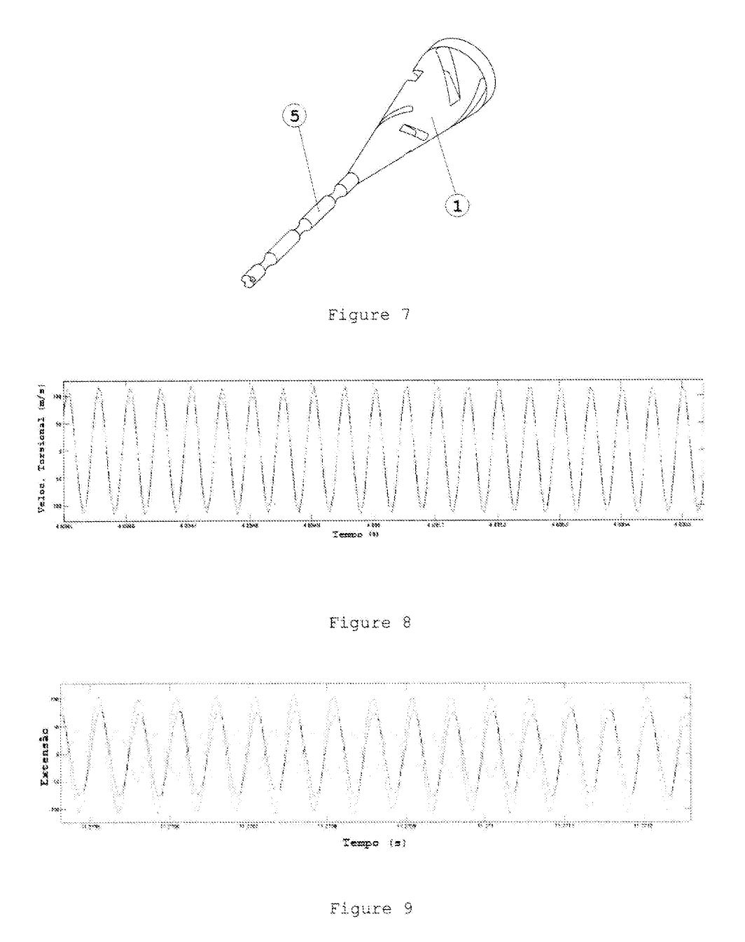

### EXAMPLE

A prototype of the equipment described herein was constructed and tested, constituted by a horn (1) and a specimen (5). Preliminary results indicate that the specimen (5) has rotational behavior which is confirmed by the signals represented in FIG. 8. A three-channel rosette-type extensometer was installed in the central groove (8), whose temporal results, which confirm the existence of a multiaxial loading, are shown in FIG. 9.

1. Equipment for multiaxial fatigue testing at ultrasonic frequencies using an axial ultrasonic exciter, characterized in that the said axial ultrasonic exciter is coupled to a horn. (1), containing a plurality of oblique slits (3) in the conical revolution surface, inclined at a certain angle with respect to the axis of the horn (1), being in turn coupled to a cylindrical shaped specimen (5) by means of mechanical joint, wherein the specimen (5) has an upper throat (7), a central throat (8) and a lower throat (9), thus the equipment operates in the resonant mode of the exciter, horn (1) and specimen (5).

2. Equipment for multiaxial fatigue testing, according to claim 1, characterized in that the horn (1) has dimensions dependent on the material from which the horn (1) is formed.

3. Equipment for multiaxial fatigue testing, according to claim 1, characterized, in that the specimen (5) has overall dimensions dependent on the material from which the specimen (5) is formed.
